(19) United States
(12) Patent Application Publication
(10) Pub. No.: US 2018/0085701 A1
(43) Pub. Date: Mar. 29, 2018

(54) STRAINERS, METHODS, AND FILTER ASSEMBLIES THEREFOR

(71) Applicant: Equistar Chemicals, LP, Houston, TX (US)

(72) Inventors: Sellamuthu G. Chellappan, Houston, TX (US); Joseph T. Buckmaster, Corpus Christi, TX (US)

(73) Assignee: Equistar Chemicals, LP, Houston, TX (US)

(21) Appl. No.: 15/714,275

(22) Filed: Sep. 25, 2017

Related U.S. Application Data
(60) Provisional application No. 62/400,315, filed on Sep. 27, 2016.

(51) Int. Cl. B01D 46/24; B01D 46/00; B01D 39/12

(52) U.S. Cl. CPC B01D 46/2403; B01D 2271/02; B01D 39/12; B01D 46/0012

(57) ABSTRACT

The present disclosure generally relates to strainers for removing particulates from fluid media, including filter assemblies for strainers having improved sealing and straining characteristics.

### CROSS-REFERENCE TO RELATED APPLICATIONS

This application claims the benefit of priority to U.S. Provisional Application No. 62/400,315, filed on Sep. 27, 2016, which is incorporated herein by reference in its entirety.

### BACKGROUND OF THE INVENTION

The present disclosure generally relates to strainers for removing particulates from fluid media, and more particularly relates to filter assemblies for strainers having improved sealing and straining characteristics.

Industrial strainers are used in a variety of applications, including inline in piping systems to prevent debris from flowing through pipes by mechanically filtering particles from the fluid media passing through the strainer. Various strainer designs are known, including Y-strainers, T-strainers, and basket strainers, among others, which include a strainer housing, or body, that is designed to withstand the pressures and other process conditions associated with the system. The strainer housing is designed to receive a removable straining element, or filter, that includes a perforated portion for filtering particles from the media passing therethrough.

However, such strainer assemblies often experience issues with particulates bypassing the straining element due to leaking and/or ineffective sealing of the straining element and strainer housing. Such particulate bypass results in fouling of downstream equipment, such as burners, pumps, meters, and compressors, which may be highly sensitive to fouled or dirty media.

Thus, there is a need for improved strainer and filter assemblies that further prevent particulates from bypassing the straining element.

### SUMMARY OF THE INVENTION

In one embodiment, the present disclosure provides a filter assembly for a strainer that may include a tubular, perforated body having a first end and an opposed second end; and a first elastomeric sealing ring disposed about the filter assembly at or near the first end of the perforated body.

One or more embodiments include the process of the preceding paragraph, wherein the filter assembly further includes a channel that is sized and shaped to receive the first elastomeric sealing ring and is configured to position the first elastomeric sealing ring about the filter assembly at or near the first end of the perforated body.

One or more embodiments include the process of any one or more of the preceding paragraphs, wherein the filter assembly further includes a reinforcing ring disposed at the first end of the perforated body, the reinforcing ring comprising a channel that is sized and shaped to receive the first elastomeric sealing ring and is configured to position the first elastomeric sealing ring about the filter assembly near the first end of the perforated body.

One or more embodiments include the process of any one or more of the preceding paragraphs, wherein the filter assembly includes the reinforcing ring and further includes (i) a tubular ring body positioned within the perforated body, and (ii) a pair of projections defining the channel at an outer surface of a first end of the reinforcing ring.

One or more embodiments include the process of any one or more of the preceding paragraphs, wherein the filter assembly further includes the projections have an outer diameter that is greater than an outer diameter of the tubular ring body.

One or more embodiments include the process of any one or more of the preceding paragraphs, wherein the filter assembly further includes the reinforcing ring comprising stainless steel.

One or more embodiments include the process of any one or more of the preceding paragraphs, wherein the filter assembly further includes the perforated body comprises a perforated backing and a mesh screen positioned adjacent the perforated backing.

One or more embodiments include the process of any one or more of the preceding paragraphs, wherein the filter assembly further includes the perforated backing comprises a stainless steel screen having a plurality of apertures therein, the apertures having a diameter of from about 1/32 inch to about ½ inch.

One or more embodiments include the process of any one or more of the preceding paragraphs, wherein the filter assembly further includes the mesh screen comprises a stainless steel mesh having a mesh size of from about 20 to about 400.

One or more embodiments include the process of any one or more of the preceding paragraphs, wherein the filter assembly further includes the tubular, perforated body is cylindrical.

One or more embodiments include the process of any one or more of the preceding paragraphs, wherein the filter assembly further includes the first elastomeric sealing ring comprises a fluoroelastomeric material.

One or more embodiments include the process of any one or more of the preceding paragraphs, wherein the filter assembly further includes a second elastomeric sealing ring disposed about the filter assembly at or near the second end of the perforated body.

In another embodiment, a strainer assembly which comprises a strainer body that comprises a first filter assembly seat; and the filter assembly as described in any one or more of the embodiments herein, is positioned within the strainer body, and wherein the first filter assembly seat is sized and shaped to mate with the first elastomeric sealing ring of the filter assembly, such that a seal is formed between the filter assembly and the first filter assembly seat.

In one or more embodiments of the preceding paragraphs, the strainer body of the strainer assembly may comprise a Y-strainer body.

In one or more embodiments of the preceding paragraphs, the strainer assembly further includes a removable cover that comprises a second filter assembly seat.

In one or more embodiments of the preceding paragraphs, the removable cover of the strainer assembly comprises a threaded hole and mating plug configured for connecting a blow down valve.

In one or more embodiments of the preceding paragraphs, the strainer assembly further comprises a gasket positioned between the removable cover and the strainer body.

In another embodiment, a method is provided for straining particulates from media, which comprises passing the media through the strainer assembly of any one of the proceeding paragraphs, such that particulates in the media larger than perforations of the perforated body of the filter assembly are filtered from the media.

In one or more embodiments of the preceding paragraphs, wherein the media is fuel gas for a burner.

The above paragraphs present a simplified summary of the presently disclosed subject matter in order to provide a basic understanding of some aspects thereof. The summary is not an exhaustive overview. Its sole purpose is to present some concepts of the present technology as a prelude to the more detailed description set forth below.

While multiple embodiments are disclosed, still other embodiments will become apparent to those skilled in the art from the following detailed description. As will be apparent, certain embodiments, as disclosed herein, are capable of modifications in various aspects without departing from the spirit and scope of the claims as presented herein. Accordingly, the drawings and detailed description are to be regarded as illustrative in nature and not restrictive.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIGS. 1A-1C are photographs showing an embodiment of a filter assembly, in accordance with the present disclosure.

FIG. 2 is a photograph showing an embodiment of a filter assembly, in accordance with the present disclosure.

FIGS. 3A and 3B are cross-sectional plan views of an embodiment of a filter assembly, in accordance with the present disclosure.

FIG. 4 is a photograph showing an embodiment of a disassembled strainer assembly.

FIGS. 5A and 5B are photographs showing an embodiment of a strainer assembly, respectively disassembled and assembled.

FIG. 6 is an exploded perspective view of an embodiment of a strainer assembly, in accordance with the present disclosure.

FIG. 7 is a cross-sectional plan view of an embodiment of a strainer assembly, in accordance with the present disclosure.

FIG. 8 is a cross-sectional plan view of an embodiment of a strainer assembly, in accordance with the present disclosure.

FIG. 9 is a photograph showing an embodiment of a partially disassembled strainer assembly.

FIG. 10 is a photograph showing an embodiment of a strainer body, in accordance with the present disclosure.

### DETAILED DESCRIPTION OF THE INVENTION

Strainer assemblies, filter assemblies therefor, and methods for straining particulates from media are provided herein, which provide improved sealing and straining characteristics. These assemblies and methods reduce particulate bypass and the resulting fouling of downstream pipes and equipment.

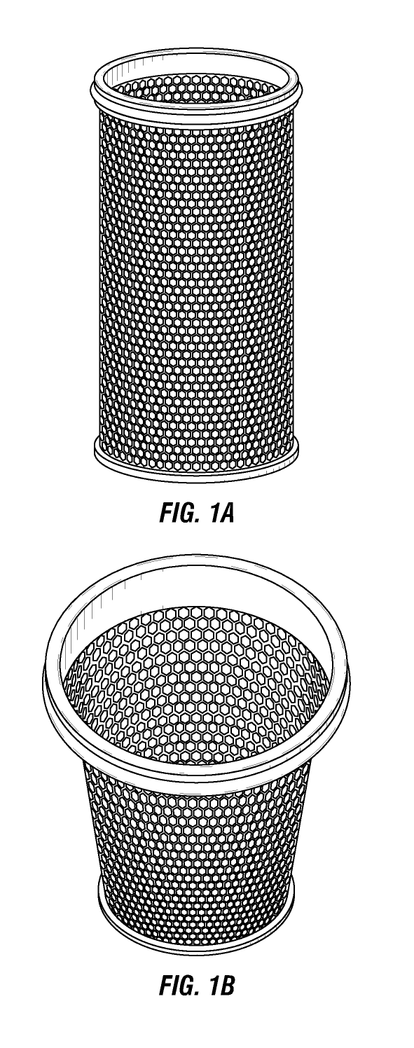

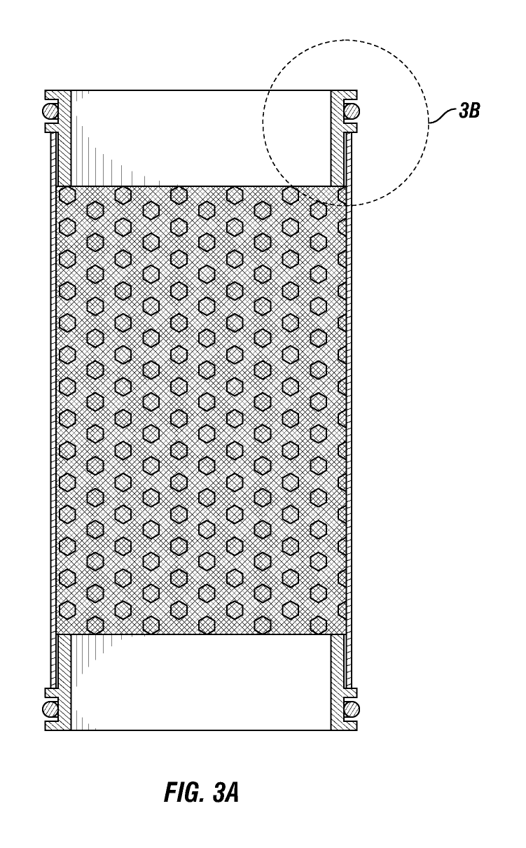

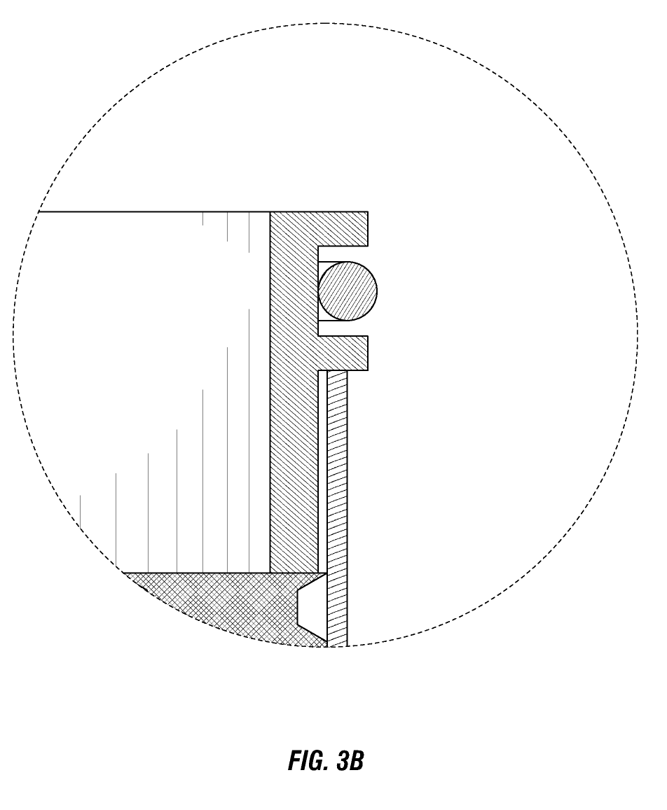

In certain aspects, filter assemblies for strainers are provided. As shown in FIGS. 1-3, a filter assembly includes a tubular, perforated body having a first end and an opposed second end, and a sealing ring disposed about the filter assembly at or near the first end of the perforated body. For example, as shown in the cross-sectional view of FIGS. 3A and 3B, the filter assembly may include a tubular, perforated body (illustrated here as items 3 and 4) as well as a sealing ring 2 that is disposed about the filter assembly at or near the first end of the perforated body.

As used herein, the term “tubular” refers to a hollow, elongated body having any suitable cross-sectional profile. For example, the tubular body may be cylindrical (i.e., have a circular cross-sectional shape), or may have a rectangular or other cross-sectional shape. In some embodiments, both ends of the tubular body are open. In other embodiments, one end of the tubular body is also perforated, such that the tubular body has a “basket” design. In some embodiments, the wall(s) of the elongated tubular body are tapered, conical, or have another suitable design.

As used herein, the term “perforated” refers to the wall(s) forming the tubular body having a plurality of apertures therein. In certain embodiments, as shown in FIGS. 3A and 3B (in which dimensions are given in inches), the perforated body is formed of a perforated backing 3 and a mesh screen 4 positioned adjacent the perforated backing 3. For example, the perforated backing may be a screen having a plurality of apertures therein, wherein the apertures have a diameter (or a major dimension in embodiments in which the apertures are not circular) of from about 1/32 inch to about ½ inch, such as about 5/32 inch. For example, the perforated backing may be formed of stainless steel, such as SAE 304 stainless steel. For example, the mesh screen may have any suitable mesh size for the desired straining effect, such as from about 20 mesh to about 400 mesh, or about 100 mesh. For example, the mesh screen may be formed of stainless steel, such as SAE 304 stainless steel. In some embodiments, the perforated body is formed solely of the perforated backing or solely of the mesh screen.

As used herein, the term “sealing ring” refers to a band having any suitable size and shape, which is configured to provide a tight closure between the filter assembly and an adjacent housing or body. The sealing ring may be formed of any suitable material, including, but not limited to, elastomeric materials, such as rubbers. In some embodiments, the sealing ring is formed of a fluoroelastomeric material, such as a VITON fluoroelastomer, which is manufactured by Chemours (Delaware). For example, the sealing ring may be a VITON o-ring manufactured by Parker Hannifin Corporation (Ohio). The material forming the sealing ring may be selected for its suitability in the relevant application, for example its suitability for exposure to the temperatures, pressures, and/or chemicals of the intended application.

In certain embodiments, as shown in FIGS. 3A and 3B, the filter assembly includes a channel that is sized and shaped to receive the sealing ring and that is configured to position the sealing ring about the filter assembly at or near the first end of the perforated body. The channel may be formed in a portion of the perforated body or may be formed in a separate structure that is coupled to the perforated body.

For example, as shown in FIGS. 3A and 3B, the filter assembly may include a reinforcing ring 1 that is disposed at the first end of the perforated body (in the illustrated embodiment, formed of perforated backing 3 and mesh screen 4) and contains the channel that is sized and shaped to receive the sealing ring 2 and is configured to position the sealing ring 2 about the filter assembly near the first end of the perforated body. As used herein, the term “reinforcing ring” refers to a band having any suitable size, shape, and material such that it may be coupled within, around, or adjacent to an end of the perforated body, and provide additional strength to the filter assembly. For example, the reinforcing ring may be designed to prevent the filter assembly from distorting under pressure during seating and operation and may ensure a tight seal is maintained between the sealing ring and the strainer body, as is discussed in detail below.

For example, the reinforcing ring 1 may include a tubular ring body at least partially positioned within the perforated body (illustrated here as items 3 and 4), and a pair of projections that define the channel at an outer surface of the end of the reinforcing ring 1. For example, the projections may extend from a portion of the tubular ring body not positioned within the perforated body. In certain embodiments, as shown in FIGS. 3A and 3B, the projections have an outer diameter (or a major dimension in embodiments in which the projections are not circular) that is greater than an outer diameter of the tubular ring body. Thus, in some embodiments, as shown in FIGS. 3A and 3B, the projections of the reinforcing ring have a diameter that is greater than the largest diameter of the perforated body. For example, the reinforcing ring may be formed of stainless steel, such as SAE 304 stainless steel. For example, the reinforcing ring may be machined to contain the channel to receive the sealing ring.

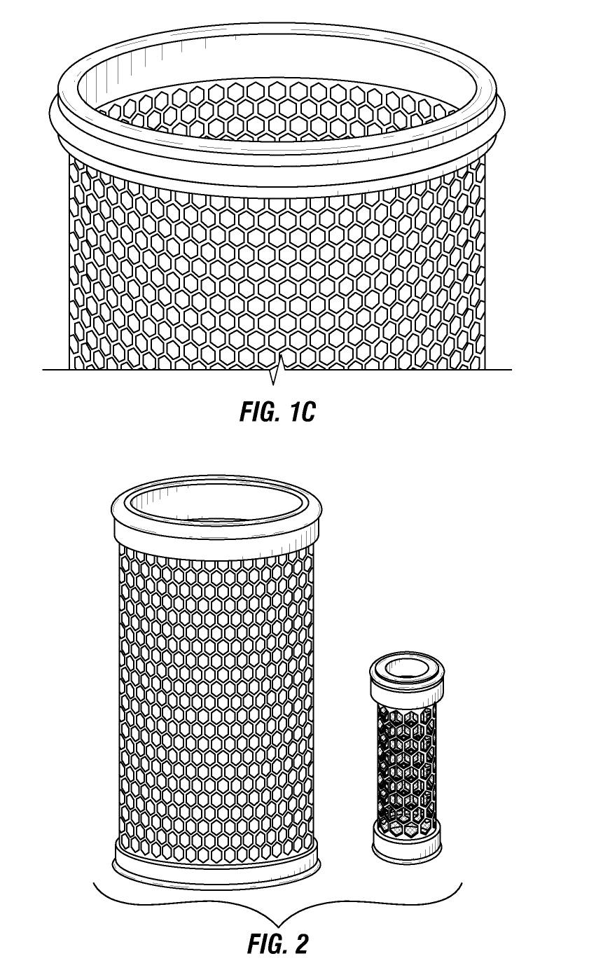

As shown in FIG. 2, in certain embodiments, the channel is positioned in the reinforcing ring such that the sealing ring is positioned at the end of the reinforcing ring (i.e., such that the sealing ring is positioned at the end of the filter assembly). In certain embodiments, as shown in FIG. 2, the projections forming the channel may have different outer diameters.

For example, as shown in FIG. 2, the channel may be positioned at the end of the reinforcing ring opposite the perforated body, and the outermost projection (i.e., opposite the perforated body) may have an outer diameter such that a sealing ring positioned in the channel extends past the outermost projection while also being secured in the channel. In such embodiments, the sealing ring advantageously is able to contact surfaces adjacent both the end and side portions of the sealing ring (i.e., surfaces transverse and parallel to the axis of the perforated body), providing for improved sealing. For example, the sealing ring and channel may be configured such that the sealing ring has a diameter larger than a depth of the channel, so that the sealing ring protrudes out of the channel. For example, positioning the sealing ring at the end of the reinforcing ring, such that it contacts both the base and sidewall surfaces of the filter assembly seat in which is it positioned, is believed to provides improved sealing because the sealing ring is able to be compressed when the cap or cover of the strainer assembly is tightened, as is discussed in more detail herein.

In other embodiments, as shown in FIGS. 1A-1C, the channel is positioned in the reinforcing ring such that the sealing ring is spaced slightly from the end of the reinforcing ring. For example, as shown in FIGS. 3A-3B, the channel may be centered at the width of the portion of the tubular body of the reinforcing ring positioned outside of the perforated body. For example, as shown in FIGS. 3A-3B, the channel may be spaced about 0.063 inches from the end of the reinforcing ring.

In certain embodiments, as shown at FIGS. 1-3, the filter assembly includes a second sealing ring disposed about the filter assembly at or near the second end of the perforated body. For example, the filter assembly may include a second channel that is sized and shaped to receive the second sealing ring and that is configured to position the sealing ring about the filter assembly at or near the second end of the perforated body. The channel may be formed in a portion of the perforated body or may be formed in a separate structure that is coupled to the perforated body. For example, the filter assembly may include a second reinforcing ring that is disposed at the second end of the perforated body and contains the channel that is sized and shaped to receive the sealing ring and is configured to position the sealing ring about the filter assembly near the second end of the perforated body. The second reinforcing ring may have any of the features described with reference to the first reinforcing ring.

In certain embodiments, the components of the filter assembly (e.g., the perforated body, including any mesh screen and/or perforated backing, and any reinforcing ring) may be coupled to one another via welding, such as induction welding, or any other suitable attachment process.

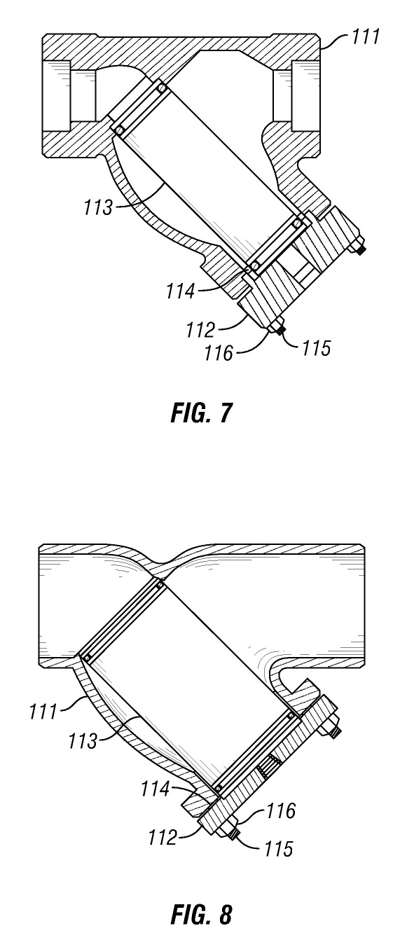

In other aspects, strainer assemblies are provided. As shown in FIGS. 7 and 8 (in which dimensions are given in inches), such strainer assemblies may include a strainer body 111 (i.e., housing) having a filter assembly seat and a filter assembly 113 having a tubular, perforated body with a sealing ring disposed about the filter assembly at or near the first end of the perforated body. For example, any embodiments of the filter assemblies described above may be used in the strainer assemblies. The filter assembly 113 is positioned within the strainer body 111, and the filter assembly seat is sized and shaped to mate with the first sealing ring of the filter assembly 113, such that a seal is formed between the filter assembly and the filter assembly seat.

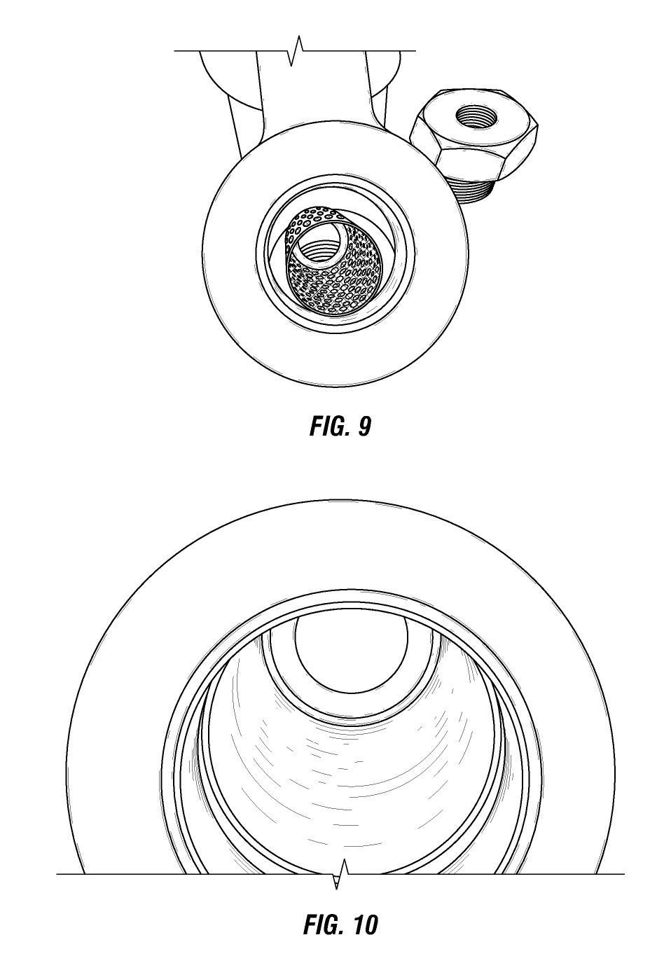

As used herein, the term “filter assembly seat” refers to the internal surface of the strainer body which receives an end of the filter assembly. For example, the filter assembly seat may be machined to have a size and shape particularly suited to mate with the sealing ring of the filter assembly. In certain embodiments, the first filter assembly seat is machined to have a recess at its sidewall to receive the first sealing ring of the filter assembly. For example, FIG. 10 is a photograph showing a first filter assembly seat having a machined recess at its sidewall, which provides relatively smooth base and sidewall surfaces of the seat for flush engagement with the sealing ring. That is, the surface of the sidewall and/or base of the filter assembly seat may be smooth to provide improved sealing surfaces for the sealing ring. For example, in embodiments in which the sealing ring protrudes out of the channel such that it contacts both the base and sidewall surfaces of the filter assembly seat, both the sidewall and base surfaces of the filter assembly may be smooth to enhance sealing at both surfaces.

In certain embodiments in which the projections of the reinforcing ring have a diameter that is greater than the largest diameter of the perforated body, the filter assembly seat also includes a recess or groove to receive the reinforcing ring.

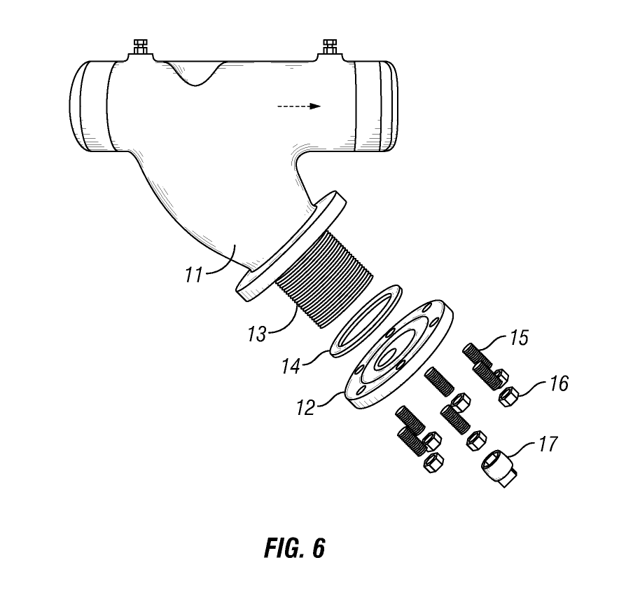

The strainer body may be any suitable strainer housing design known in the art. In certain embodiments, the strainer body is a Y-strainer body or a T-strainer body. The strainer body may be of any suitable size for the desired application. For example, the strainer body may be a ½ inch to 3 inch Y-strainer, such as a 1 inch or 2 inch Y-strainer. For example, the strainer body may be a Y-strainer body, such as shown in FIG. 6. In certain embodiments, as shown in the exploded view of FIG. 6, the strainer body 11 is configured to receive filter assembly 13 and a cover, or cap, 12 is configured to attach to the strainer body 11 at or near the second end of the filter assembly 13. The cover 12 may be removably attached to the strainer body 11 to provide for removal and cleaning of the filter assembly 13. For example, the strainer body and cover maybe made of any suitable materials known in the art, such as cast carbon steel.

In certain embodiments, as shown in FIGS. 7 and 8, the removable cover 112 defines a second filter assembly seat that receives the second end of the filter assembly 113. The second filter assembly seat may be machined to have a size and shape particularly suited to mate with a second sealing ring of the filter assembly, and may have any features as described herein with reference to the first filter assembly seat. Thus, in embodiments in which the filter assembly includes two sealing rings at opposing ends, the filter assembly may be sealed to the strainer body at both ends.

In certain embodiments, as shown in FIG. 6, the removable cover 12 includes a threaded hole and a mating plug 17 configured for connecting a blow down valve. In certain embodiments, a blow down valve is welded to the cover. In certain embodiments, the removable cover includes a threaded hole for mating with a threaded ball or tubing valve.

In certain embodiments, as shown in FIG. 6, the strainer assembly also includes a gasket 14 positioned between the removable cover 12 and the strainer body 11. The gasket may be configured to provide a seal between the strainer body 11 and the cover 12. For example, the gaskets may be made of any suitable material known in the art, such as stainless steel. For example, the gaskets may be 316 stainless steel tanged gaskets or 316 stainless steel spiral wound gaskets.

In certain embodiments as show in FIG. 6, the strainer assembly includes studs 15 and nuts 16 to couple the cover 12 to the strainer body 11. Other suitable fastening mechanisms known in the art may also be used.

In some embodiments, as shown in FIGS. 7 and 8, the strainer assembly includes a Y-strainer body 111 that receives filter assembly 113, and a removable cover 112. The removable cover 112 is sealed to the strainer body 111 by gasket 114. The removable cover is coupled to the strainer body 111 by studs 115 and nuts 116.

In further aspects, methods for straining particulates from media are provided. Such methods include passing the media through any strainer assembly as described herein, such that particulates in the media larger than perforations of the perforated body of the filter assembly are filtered from the media. For example, the media may be any fluid media containing particulates to be filtered. In certain embodiments, the media is fuel gas for a burner, such as a low NOx burner.

### EXAMPLES

Improved strainer assemblies were manufactured in accordance with the present disclosure and installed in an industrial furnace system and their performance was compared to traditional strainer assemblies. The furnace system includes a radiant section consisting of vertical tubes and a convection section consisting of banks of horizontal tubes. In the convection section, feed is heated first in the feed preheat section and then along with dilution steam in the mixed feed preheat section. Between the feed preheat section and the mixed feed preheat section is a section called the “economizer” where boiler feed water is preheated before going to the steam drum. Each furnace are also provided with combustion air supply such as forced draft, natural draft, balanced draft and induced draft.

Feedstock such as ethane, propane & naphtha are cracked to produce cracked gas containing hydrogen, methane, ethane, ethylene, propylene etc. Then the cracked gas is compressed and separated (e.g., ethylene and propylene separated as product in the downstream distillation column). In the cracking process, the feedstock is pre-heated from 100° F. in the top section, called the convection section, of a furnace then mixed with dilution steam and then heated up to 1250° F. with flue gas from the fire box. Then the mixed feed is provided to a radiant section of the furnace and further heated to feedstock cracking temperature such as 1400+° F.

Heat is provided to the cracking furnaces or process heaters using fuel such as natural gas or natural gas mixed with plant produced fuel gas. Mostly all of the fuel gas, including natural gas, contains particulates such as pipe scales. The fuel gas is mixed with air in a burner and burned to heat the feedstock or process gas. The dirty fuel gas will plug the burner tips and the flame produced in the burner (wall mounted or floor mounted burners) will impinge on the furnace tubes (coil) and reduce the life of the radiant tubes. In addition, modern burners installed in these types of heaters may be low NOx (nitrous oxide) to ultra-low NOx burners (ULNB) to meet environmental regulations and flue gas emissions permits. In such burners, if the NOx emissions are higher than the State permit emissions due to dirty fuel gas entering the burner, plant operations and production rates are impacted. In addition, cleaning the burners regularly, if plugged due to pipe scales, results in higher maintenance costs.

To minimize the fuel gas plugging the burner tips with pipeline scales and other solid particles which impacts the burner performance, a Y-strainer with a filter screen was installed in the fuel gas supply line for each burner with a predetermined screen mesh size, based upon the burner tip hole sizes (e.g., 100 mesh). However, it was discovered that these traditional filters experienced many issues. For example, there was a significant gap at the bottom and top of the filter and the filter was not sealing well so the particulates were bypassing the filter screens and plugging the burner tips and impacting the furnace performance. For example, low NOx burners having traditional inline Y-strainer assemblies upstream of the burners were found to require constant cleaning of plugged burner tips due to particulate bypass in the Y-strainers.

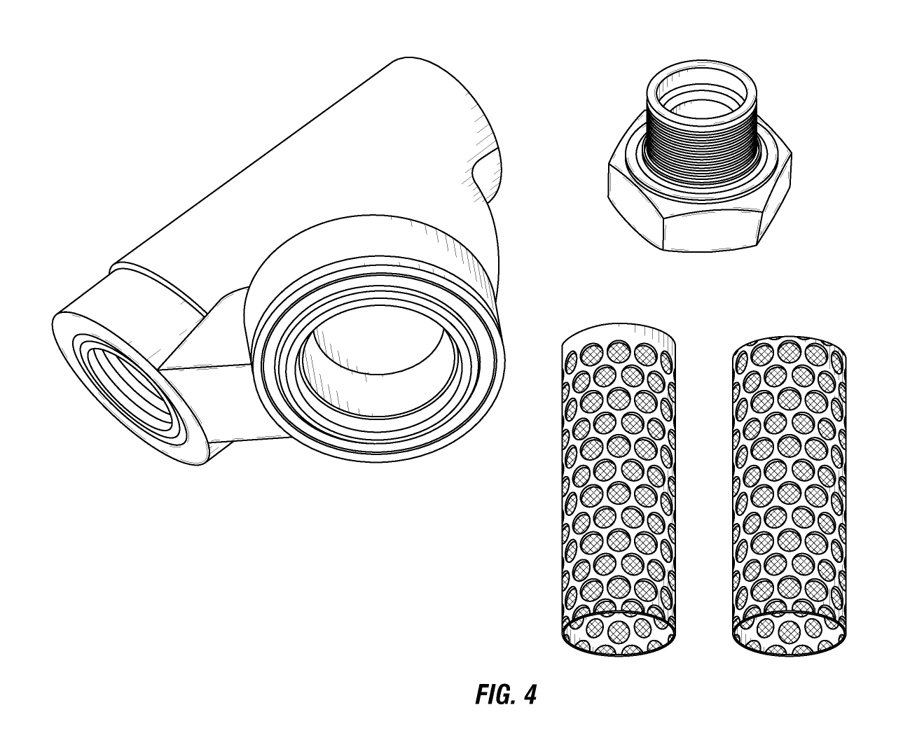

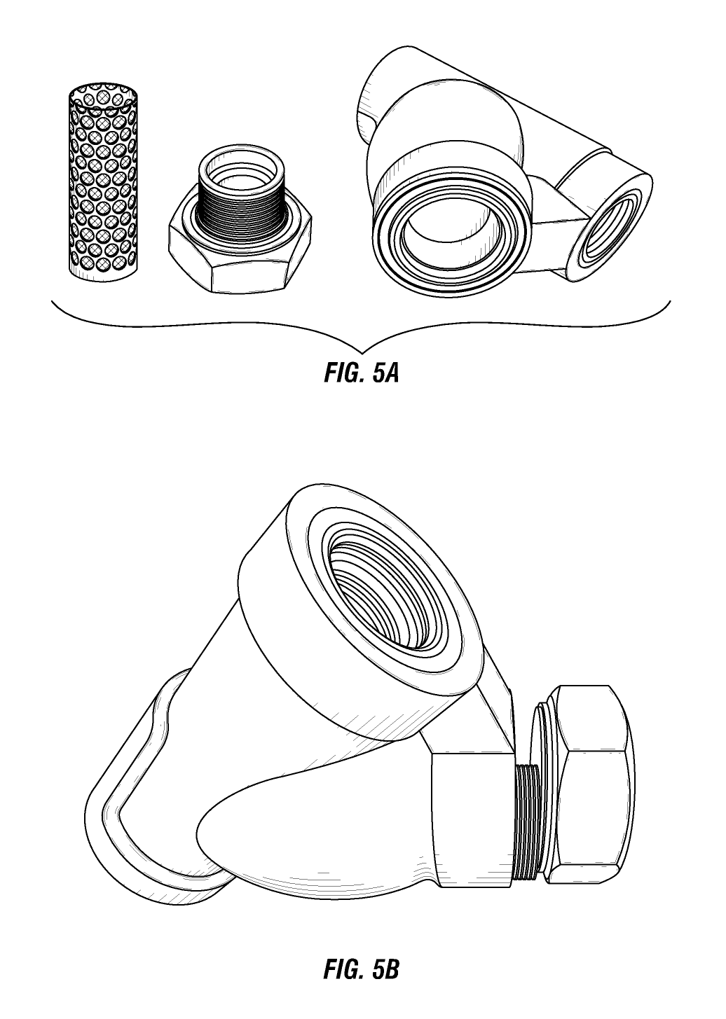

Traditional filter assemblies for such Y-strainer assemblies are pictured in FIGS. 4, 5A and 5B, and 9. As can be seen in these figures, the traditional filter has no reinforcing or sealing rings, and instead the filter is flimsy with ragged, cut ends that are unable to seal tightly. Moreover, these strainer assemblies display loose tolerances in the strainer body and cover with the filter, and as a result seal poorly.

Further issues arise when the traditional filter is removed from the strainer body for cleaning in the field. For example, when the filter is placed back into the strainer body recess, it has no stability or structural guidance to attain the correct position within the strainer seats, so it often lies down against the strainer body, resulting in improper placement of the filter and increased particulate bypass. Additionally, when the cover is reattached in the field after cleaning, it often will contact the filter because the filter is not aligned with the seat in the cover, which results in damage in traditional, non-reinforced filters. For example, FIGS. 4 and 9 illustrate the damage that occurs at the ends of traditional filters, which result in even more particulate bypass.

The improved filter and strainer assemblies described herein were found to significantly improve sealing between the filter assembly and the strainer body, while also reducing the likelihood of damage and/or improper positioning of the filter assembly after cleaning. Specifically, the sealing rings at the end(s) of the perforated body provide improved sealing with the strainer body, limiting the ability of particulates to travel therebetween. Additionally, reinforced ends (e.g., with the reinforcing rings) of the filter assembly provided improved stability and strength to the perforated body.

Additionally, the strainer body may be machined to provide improved mating surfaces for the sealing ring(s) of the filter assemblies, which may improve both sealing and alignment of the filter within the strainer body. That is, the present strainer bodies may have machined recesses with tight tolerances to maintain the filter assembly alignment regardless of the strainer orientation. When a new or replaced filter assembly is inserted into the machined recess in the strainer body, the sealing ring helps to keep the filter assembly in place so the filter stays in place and the close tolerance of the reinforcing ring keeps the filter assembly aligned with the cover's machined recess, making for an easy cover installation with no damage to the filter assembly.

Such improved Y-strainers with the filter assemblies of the present disclosure (as pictured in FIG. 2) were installed in an ethylene furnace burner and displayed no fouling or plugging over a period of more than a year. In addition, the installation of the filter assembly in the Y-strainer body was much easier versus the traditional filters. For example, as pictured in FIG. 10, the inside seating surface of the strainer body has a machined recess into the strainer body resulting in relatively smooth sides where the sealing ring seats. The shiny surface is where the end of the traditional filter sits. The scratches show how poorly the traditional filter would have sealed due to rough ends. Thus, the presently disclosed filter assemblies, strainer assemblies and methods reduce the bypassing of particulates to downstream equipment.

While the disclosure has been described with reference to a number of example embodiments, it will be understood by those skilled in the art that the disclosure is not limited to such disclosed embodiments. Rather, the disclosed embodiments can be modified to incorporate any number of variations, alterations, substitutions, or equivalent arrangements not described herein, but which are commensurate with the spirit and scope of the disclosure.

We claim:

1. A filter assembly for a strainer, comprising:
a tubular, perforated body having a first end and an opposed second end; and
a first elastomeric sealing ring disposed about the filter assembly at or near the first end of the perforated body.

2. The filter assembly of claim 1, further comprising a channel that is sized and shaped to receive the first elastomeric sealing ring and is configured to position the first elastomeric sealing ring about the filter assembly at or near the first end of the perforated body.

3. The filter assembly of claim 1, further comprising a reinforcing ring disposed at the first end of the perforated body, the reinforcing ring comprising a channel that is sized and shaped to receive the first elastomeric sealing ring and is configured to position the first elastomeric sealing ring about the filter assembly near the first end of the perforated body.

4. The filter assembly of claim 3, wherein the reinforcing ring comprises (i) a tubular ring body positioned within the perforated body, and (ii) a pair of projections defining the channel at an outer surface of a first end of the reinforcing ring.

5. The filter assembly of claim 4, wherein the projections have an outer diameter that is greater than an outer diameter of the tubular ring body.

6. The filter assembly of claim 3, wherein the reinforcing ring is formed of stainless steel.

7. The filter assembly of claim 1, wherein the perforated body comprises a perforated backing and a mesh screen positioned adjacent the perforated backing.

8. The filter assembly of claim 7, wherein the perforated backing comprises a stainless steel screen having a plurality of apertures therein, the apertures having a diameter of from about 1/32 inch to about ½ inch.

9. The filter assembly of claim 7, wherein the mesh screen comprises a stainless steel mesh having a mesh size of from about 20 to about 400.

10. The filter assembly of claim 1, wherein the tubular, perforated body is cylindrical.

11. The filter assembly of claim 1, wherein the first elastomeric sealing ring comprises a fluoroelastomeric material.

12. The filter assembly of claim 1, further comprising a second elastomeric sealing ring disposed about the filter assembly at or near the second end of the perforated body.

13. A strainer assembly, comprising:
a strainer body comprising a first filter assembly seat; and
the filter assembly of claim 1 positioned within the strainer body,
wherein the first filter assembly seat is sized and shaped to mate with the first elastomeric sealing ring of the filter assembly, such that a seal is formed between the filter assembly and the first filter assembly seat.

14. The strainer assembly of claim 13, wherein the strainer body comprises a Y-strainer body.

15. The strainer assembly of claim 13, further comprising a removable cover that comprises a second filter assembly seat.

16. The strainer assembly of claim 15, wherein the removable cover comprises a threaded hole and mating plug configured for connecting a blow down valve.

17. The strainer assembly of claim 15, further comprising a gasket positioned between the removable cover and the strainer body.

18. A method for straining particulates from media, comprising passing the media through the strainer assembly of claim 13, such that particulates in the media larger than perforations of the perforated body of the filter assembly are filtered from the media.

19. The method of claim 18, wherein the media is fuel gas for a burner.
